(19) United States
(12) Patent Application Publication
(10) Pub. No.: US 2018/0095484 A1
(43) Pub. Date: Apr. 5, 2018

(54) TEMPERATURE CONTROL DEVICE

(71) Applicant: Josmon C. George, Fortville, IN (US)

(72) Inventor: Josmon C. George, Fortville, IN (US)

(21) Appl. No.: 15/554,992

(22) PCT Filed: Feb. 24, 2016
(86) PCT No.: PCT/US2016/019251

§ 371 Date: Aug. 31, 2017

Related U.S. Application Data
(60) Provisional application No. 62/216,355, filed on Sep. 9, 2015.
(60) Provisional application No. 62/126,793, filed on Mar. 2, 2015.

(51) Int. Cl. G05D 27/02; G05D 22/02; G05D 23/19; F24F 11/30; F24F 11/67

(52) U.S. Cl. CPC G05D 27/02; G05D 22/02; F24F 11/52; F24F 11/30; F24F 11/67; G05D 23/1902

(57) ABSTRACT

The present disclosure provides a temperature control device. In one exemplary embodiment, a temperature control system includes a heating unit, a cooling unit, a temperature detection unit, and a temperature control unit. The temperature control unit has a user interface for accepting a user input for a first temperature and a user input for a second temperature with the first temperature being lower than the second temperature. When the temperature detection unit detects a current temperature outside a range between the first and second temperature, the temperature control unit activates either the heating unit or the cooling unit until the temperature detection unit detects a temperature between the first temperature and second temperature.

### CROSS-REFERENCE TO RELATED APPLICATIONS

This application claims the benefit of U.S. Provisional Patent Application 62/126,793, entitled TEMPERATURE CONTROL DEVICE, filed Mar. 2, 2015 and U.S. Provisional Patent Application 62/216,355, entitled TEMPERATURE CONTROL DEVICE, filed Sep. 9, 2015, the disclosures of each of which are hereby incorporated by reference in their entirety.

### FIELD

The present disclosure relates to environmental control systems and methods. More particularly, the present disclosure relates to systems and methods for controlling the heating, cooling and/or humidity levels of the interior of one or more buildings.

### BACKGROUND AND SUMMARY OF THE DISCLOSURE

Environmental control of confined spaces is generally accomplished through the use of heating, ventilating, and air conditioning (“HVAC”) systems or through the opening of windows and doors. A thermostat is typically used to control HVAC systems, whereas a person is required for manually opening and closing doors and windows.

Typical HVAC systems include a thermostat and temperature sensors for determining the temperature within the confined space. Users input desired temperature settings into the thermostat and when the temperature within the confined space is determined to be different from the desired temperature setting, the thermostat acts as an on switch for the HVAC system to bring the temperature within the confined space to the desired temperature setting. Likewise, when the temperature within the confined space is determined to be equal to the desired temperature setting, the thermostat acts as an off switch for the HVAC system.

Since the mid-1950's energy demand for heating and cooling buildings has risen. For example, approximately twenty percent of the electricity generated in the United States is used only for cooling buildings. As the demand for energy to cool and heat buildings has increased, costs to energy consumers have also risen. Additionally, pollution caused by the production of energy for heating and cooling buildings has also increased.

As a result of the increased energy consumption, pollution, and costs resulting from heating and cooling buildings, manufacturers and consumers of heating and cooling systems have placed a greater focus on energy conservation. For example, some users may attempt to limit their personal use of air conditioning or furnace systems. Additionally, some thermostats allow users to input different desired temperature settings for different time periods on specific days (e.g., when in a heating mode allowing the user to set a lower desired temperature setting for hours the user is at work) in order to reduce the overall operational time of their HVAC system. Further, the U.S. Department of Energy implemented the Seasonal Energy Efficiency Ratio (SEER) in order to regulate energy consumption by air conditioners. For at least these reasons, systems and methods which reduce the energy consumption required to control the heating, cooling, and humidity levels of confined spaces are important for decreasing energy demand, pollution, and consumer energy costs.

In one embodiment, a temperature control system comprises a heating unit, a cooling unit, a temperature detection unit, and a temperature control unit. The temperature control unit has a user interface for accepting a user input for a first temperature and a user input for a second temperature with the first temperature being lower than the second temperature. When the temperature detection unit detects a current temperature outside a range between the first and second temperature, the temperature control unit activates either the heating unit or the cooling unit until the temperature detection unit detects a temperature between the first temperature and second temperature.

In another embodiment, the temperature control system further comprises a humidity compensation mode which includes a humidity detection unit that detects a current humidity, a humidity control unit that accepts a user input for the desired humidity and accepts a user input for a humidity compensation temperature difference.

In another embodiment, a temperature control unit comprises a temperature detection unit, a user interface for accepting a first user input temperature and a second user input temperature where the first user input temperature and the second user input temperature define a first range. When the temperature detection unit detects a temperature within the first range, no heating or cooling is activated.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings.

FIG. 1 is a flow chart of an exemplary method of the present disclosure;

FIG. 2 is a continuation of the flow chart in FIG. 1 of an exemplary method of the present disclosure;

FIG. 3 is a continuation of the flow chart in FIG. 1 of an exemplary method of the present disclosure; and

FIG. 4 is a front view of an exemplary temperature control unit where the user will input desired temperature settings; and

FIG. 5 is a schematic view of an exemplary temperature control system.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF THE DRAWINGS

The embodiments disclosed herein are not intended to be exhaustive or limit the disclosure to the precise form disclosed in the following detailed description. Rather, the embodiments are chosen and described so that others skilled in the art may utilize their teachings.

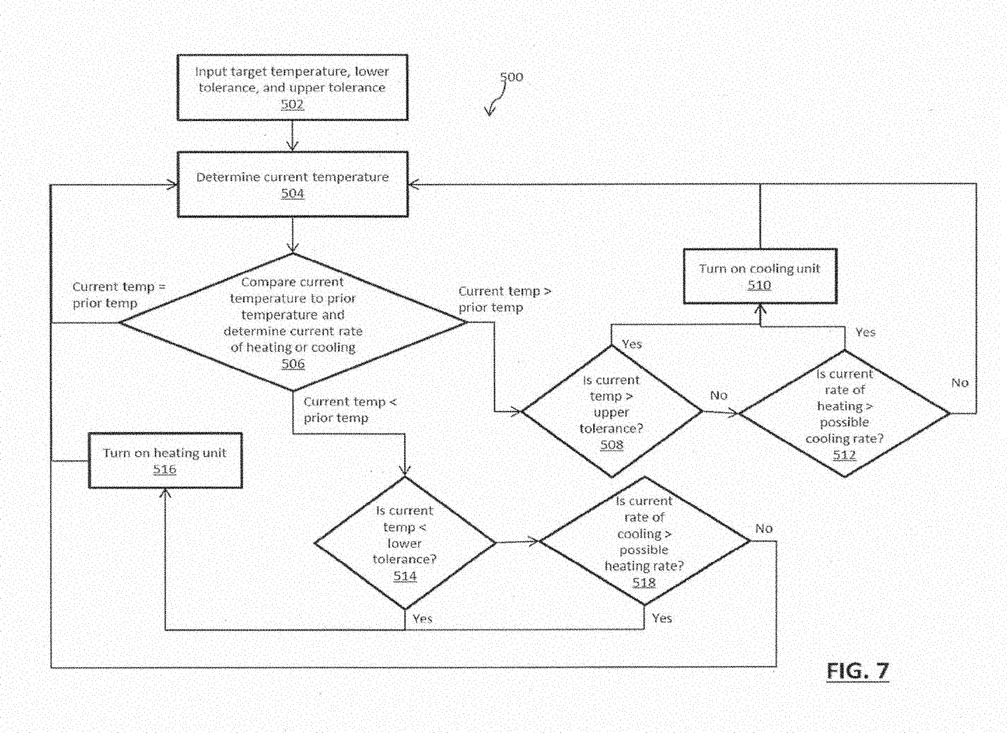

Referring first to FIG. 5, an exemplary temperature control system 300 is illustrated. Temperature control system 300 illustratively operates with a temperature range rather than a set temperature. In the exemplary embodiment illustrated in FIG. 5, temperature control unit 302 also functions as a humidity control unit 304. In other embodiments (not shown), temperature control system 300 may include only a temperature control unit 302, or the functionality for temperature control unit 302 and humidity control until 304 may be contained within separate units.

As shown in FIG. 5, temperature control system 300 controls heating unit 306 and cooling unit 308. Temperature control system 300 is operatively connected to a temperature sensor 310, such as a thermometer, and a humidity sensor 312. In one embodiment, the temperature control system 300 controls heating unit 306 and/or cooling unit 308 using proportional-integral-derivative (“PID”) functionality, although other suitable functionality, including but not limited to proportional, proportional-integral, proportional-derivative, and offset functionality, may also be used.

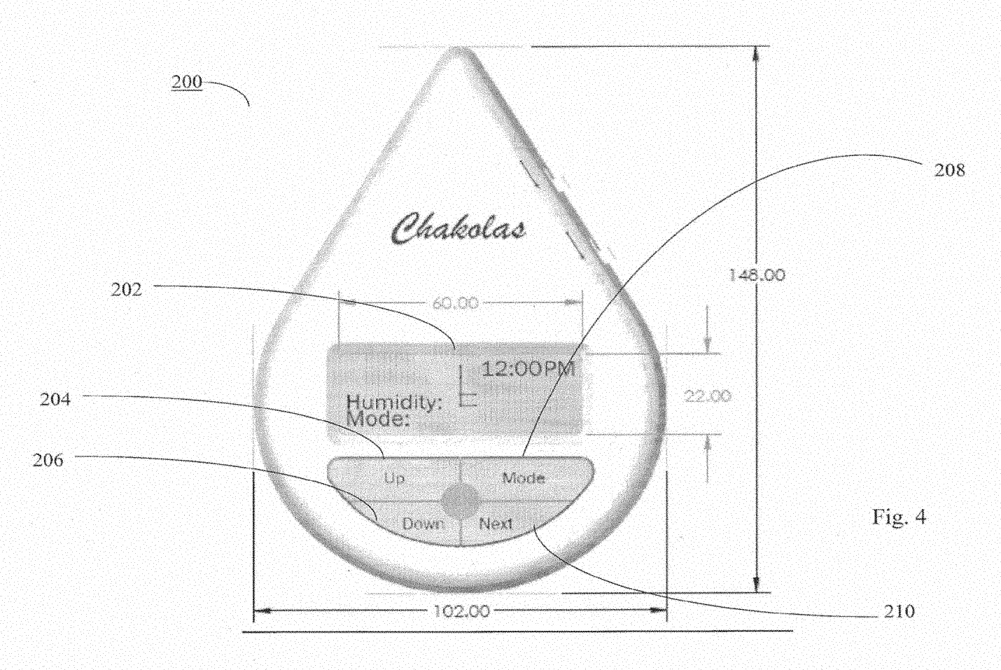

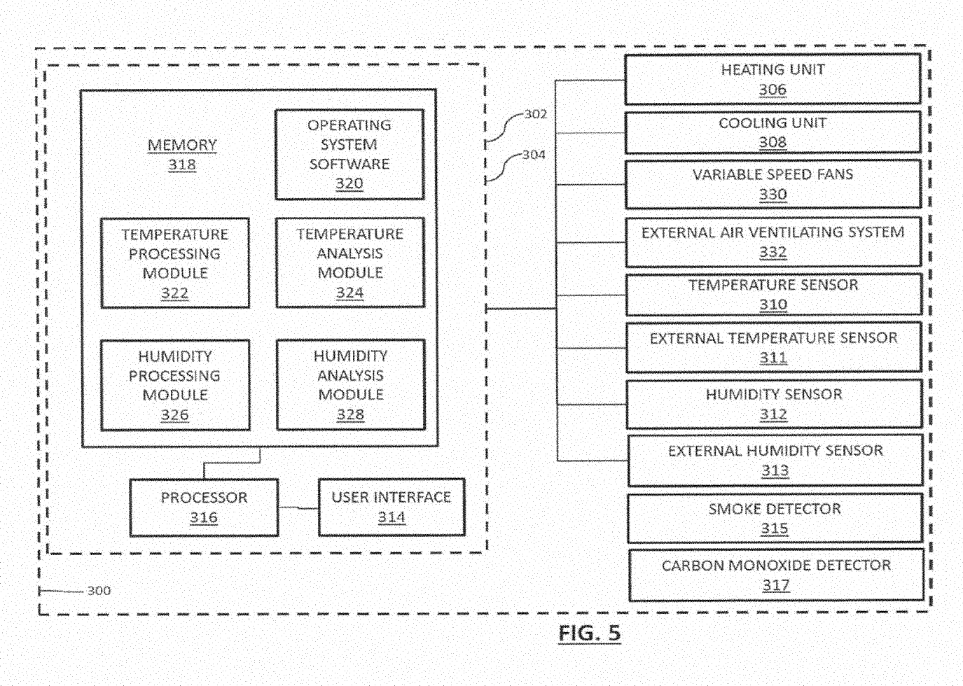

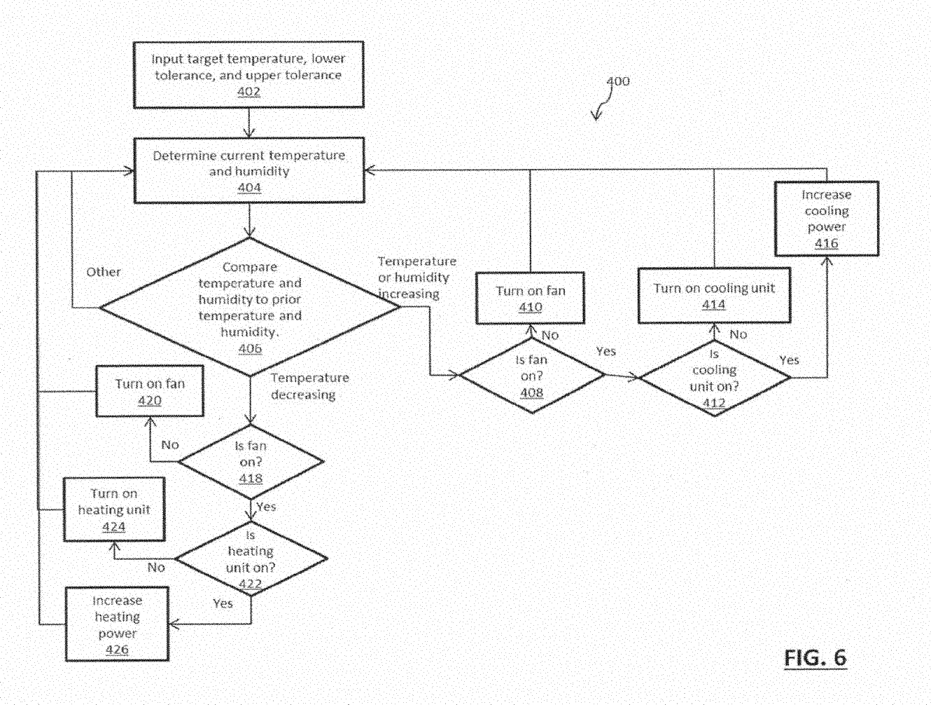

In the exemplary embodiment shown in FIG. 5, temperature control system 300 further includes a user interface 314. In one embodiment, the user interface 314 includes one or more input/output modules providing an interface between the temperature control system 300 and an operator, an environment, or both. Exemplary input members include, without limitation, buttons, switches, keys, a touch display, a microphone, a camera or other optical reader, a keyboard, a mouse, a transceiver, a sensor, and other suitable devices or methods for providing information to controller. Exemplary output devices include, without limitation, lights, a display (such as a touch screen), printer, vibrator, speaker, visual devices, audio devices including alarm/speaker, tactile devices, transceiver, and other suitable devices or methods for presenting information to an operator or a machine. In one exemplary embodiment, at least part of user interface 314 is provided as control unit 200, including display 202 and button controls 204, 206, 208, and 210, as discussed in detail below and shown in FIG. 4.

As discussed in more detail below, temperature control system 300 illustratively operates with a temperature range rather than a set temperature. In one exemplary embodiment, temperature control system 300 activates cooling unit 308 at a cooling start temperature, and temperature control system 300 activates heating unit 306 at a heating start temperature, wherein the cooling start temperature is different than the heating start temperature.

Temperature control system 300 illustratively includes one or more processors 316 with access to memory 318. Processor 316 may comprise a single processor or may include multiple processors, located either locally with temperature control unit 302, humidity control unit 304, or accessible across a network. Memory 318 is a computer readable medium and may be a single storage device or may include multiple storage devices, located either locally with temperature control unit 302, humidity control unit 304, or accessible across a network. Computer-readable media may be any available media that may be accessed by processor 316 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by temperature control system 300.

Memory 318 may include one or modules or programs, including, without limitation, operating system software 320, one or more temperature modules such as temperature processing module 322 and temperature analysis module 324, and one or more humidity modules such as humidity processing module 326 and humidity analysis module 328.

In the exemplary embodiment shown in FIG. 5, temperature control system 300 is further capable of controlling a humidifier 307, a dehumidifier 309, variable speed fans 330, and an external air ventilating system 332. In addition, temperature control system 300 includes an external temperature sensor 311 and an external humidity sensor 313.

In the exemplary embodiment shown in FIG. 5, the temperature control system 300 further includes at least one smoke detector 315 and at least one carbon monoxide detector 317. Upon the smoke detector 315 detecting smoke or the carbon monoxide detector 317 detecting carbon monoxide, temperature control system 300 will alert an emergency service by sending an alert, such as a call or a text, to a predetermined emergency number. Upon detection of smoke and/or carbon monoxide, the temperature control system 300 shuts down heating unit 306, cooling unit 308, and variable speed fans 330, and opens external air ventilating system 332.

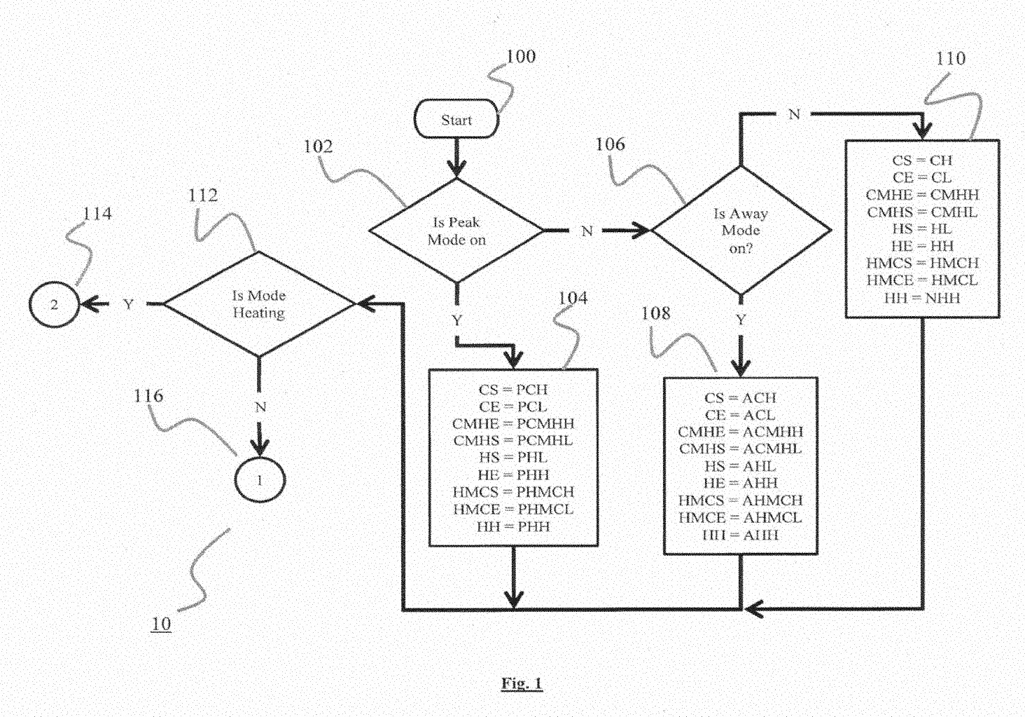

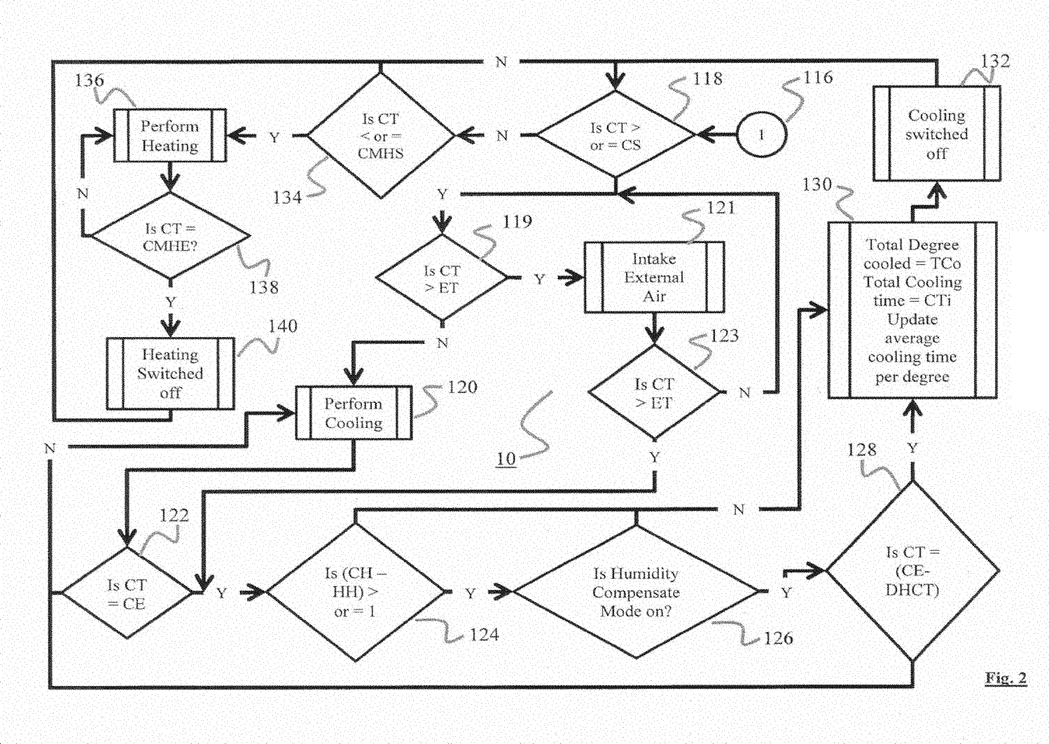

Referring next to FIG. 1, an exemplary method 10 for an exemplary temperature control system, such as temperature control system 300 (FIG. 5), is illustrated. At step 100, temperature control system 300 receives from a user values for a cooling start temperature (CS), a cooling end temperature (CE), a cooling mode heat end temperature (CMHE), a cooling mode heat start temperature (CMHS), a heating start temperature (HS), a heating end temperature (HE), a heating mode cooling start temperature (HMCS), a heating mode cool end temperature (HMCE), and a high humidity (HH). In one exemplary embodiment, the values are received through user interface 314. In one exemplary embodiment, one or more of the values may be based on a default value provided by temperature control system 300. From step 100, the user can select an operational mode by pressing the mode control button 208 (FIG. 4) on a control unit 200 (FIG. 4). In one embodiment, the modes that a user can select from include: a normal mode, an away mode, and a peak mode.

In one embodiment, a user selects normal mode at step 100. System 300 then progresses to step 102, where system 300 receives a “No” response and proceeds to step 106, which also returns a “No” response to system 300. System 300 then proceeds to step 110 and determines variable values based on the user inputs received in step 100. At step 110, cooling start temperature is set to the input value for CH, which is the normal cooling high temperature. The cooling end temperature is set to the input value for CL, which is the normal cooling low temperature. The cooling mode heat end temperature, is set to the input value for CMHH, which represents a normal cool mode heat high temperature. The cooling mode heat start temperature is set to the input value for CMHL, which is the normal cooling mode heat low temperature. Additionally, the heating start temperature is set to the input value for HL, normal heating low temperature; the heating end temperature is set to the input value for HH, normal heating high temperature; the heat mode cooling start temperature is set to the input value for HMCH, which represents normal heat mode cool high temperature; the heat mode cooling end temperature is set to the input value for HMCL, which represents normal heat mode cool low temperature; and the high humidity is set to the input value for NHH, normal high humidity.

After a user selects Normal mode, system 300 proceeds to step 112, where system 300 determines if a heating mode is on, based in part on a user inputs. If the heating mode is on, system 300 receives a “Yes” response and system 300 proceeds to step 114. If heating mode is off, system 300 receives a “No” response and proceeds to step 116. In another embodiment, a heating mode and a cooling mode can be active simultaneously.

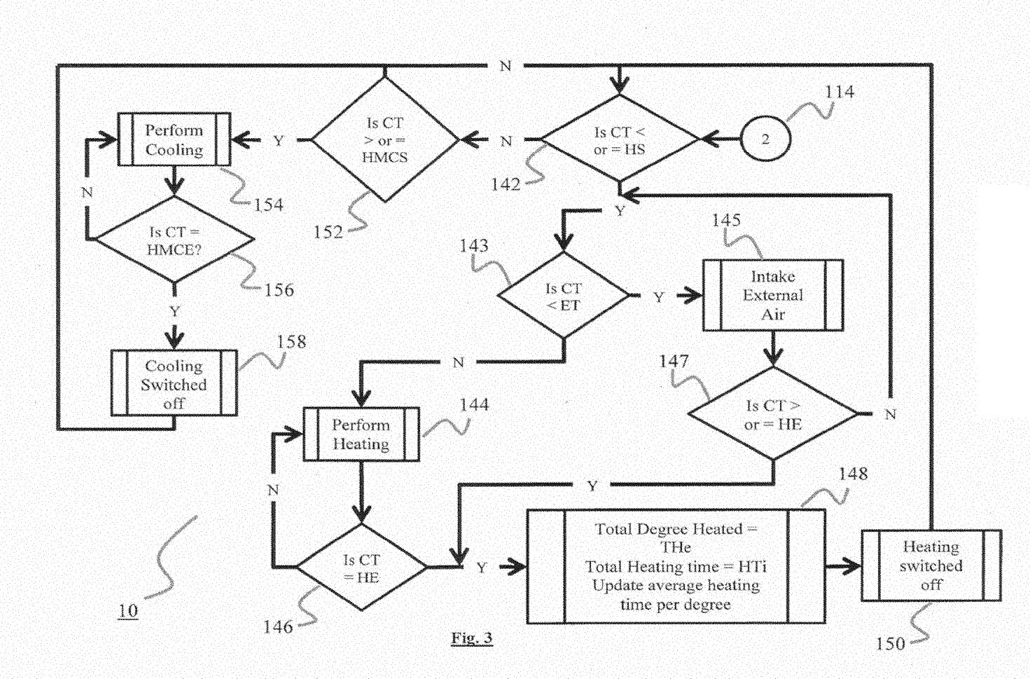

Referring to FIG. 2, at step 116, a heating mode is inactive and system 300, now in a cooling mode, proceeds to step 118. At step 118, a temperature sensor 310 (FIG. 5) detects whether the current temperature, denoted as CT, is greater than or equal to a normal cooling high temperature. If the temperature detection unit detects that the current temperature is greater than the normal cooling high temperature, then system 300 proceeds to step 120 where a cooling unit 308 (FIG. 5) is activated by system 300. In one embodiment, a cooling unit 308 of system 300 is an air conditioning unit. While system 300 is performing its cooling operation, the temperature sensor 310 (FIG. 5) continues monitoring the current temperature and the temperature control unit 302 compares the current temperature to the normal cooling low temperature as shown in step 122. When these two values are equal, or the current temperature is less than the normal cooling low temperature, system 300 proceeds to step 124. At step 124, a humidity sensor 312 (FIG. 5) of system 300 measures a current humidity (denoted as CH). A humidity control unit 304 (FIG. 5) then measures the difference between the current humidity and a normal high humidity value. If the difference is greater than or equal to 1% relative humidity, system 300 proceeds to step 126. If the difference between the current humidity and the normal high humidity is not greater than or equal to 1% relative humidity, system 300 proceeds to step 130, where total degree cooled and total cooling time are measured and an average cooling time per degree is calculated and updated by temperature analysis module 324 and temperature processing module 322 (FIG. 5). From step 130, system 300 proceeds to step 132 where cooling unit 308 (FIG. 5) is switched off by system 300, and system 300 then returns to step 118.

In one embodiment, the average cooling time per degree is determined and updated as a total degree cooled per total time by temperature processing module 322 and temperature analysis module 324. Based on the live data stored in memory 318 of system 300 (FIG. 5), temperature control unit 302 utilizes this information to notify the user via user interface 314 of the approximate time it will take to reach the settings inputted by the user.

At step 126, system 300 checks to see if humidity compensate mode is on. The humidity compensate mode can be switched on or off for normal mode such that the settings could apply humidity compensate only during normal hours and not for away or peak mode. If the humidity compensate mode is off, then system 300 proceeds to steps 130 and 132 as described above. If the humidity compensate mode is on, system 300 proceeds to step 128 where the humidity control unit 304 (FIG. 5) determines whether the current temperature is equal to the difference between the normal cooling low temperature and a humidity compensation delta. In one embodiment, the humidity compensation delta has a default value for system 300. In another embodiment, the humidity compensation delta is a value that a user enters into system 300 using user interface 314. If the difference between the normal cooling low temperature and a humidity compensation delta does not equal the current temperature, system 300 returns to step 120. At step 120, cooling is performed, and the system behavior associated with steps 122, 124, 126, and 128 are executed. If the difference between the normal cooling low temperature and a humidity compensation delta is to the current temperature, then system 300 proceeds to steps 130 and 132 as described above.

In one exemplary embodiment, the cooling mode of system 300 also features an automatic heating switch over temperature range which is below the lower range of the normal cooling low temperature and the normal cooling high temperature. The automatic heating switch over temperature range is defined between a normal cool mode heat low temperature and a normal cool mode heat high temperature.

Referring back to step 118, if the temperature control unit 302 (FIG. 5) detects that the current temperature is not greater than or equal to the normal cooling high temperature, system 300 proceeds to step 134 where temperature control unit 302 (FIG. 5) measures the current temperature with temperature sensor 310 and determines whether the current temperature is less than or equal to a normal cool mode heat low temperature. If the current temperature is not less than or equal to the normal cool mode heat low temperature, then system 300 returns to step 118.

If the current temperature is less than or equal to the normal cool mode heat low temperature, then a heating unit 306 (FIG. 5) of system 300 is activated as indicated in step 136. In one embodiment, a heating unit 306 (FIG. 5) of system 300 is a heater. Once the heating unit 306 (FIG. 5) is active, system 300 proceeds to step 138. At step 138, heating unit 306 (FIG. 5) is active until the temperature sensor 310 (FIG. 5) detects that the current temperature is equal to a normal cool mode heat high temperature. Once the temperature sensor 310 (FIG. 5) detects that the current temperature is equal to the normal cool mode heat high temperature, system 300 proceeds to step 140 where the heating unit 306 (FIG. 5) is switched off. System 300 then proceeds to step 118.

Referring now to FIG. 3, a heating mode is active at step 114. From step 114, system 300 proceeds to step 142 where a temperature sensor 310 (FIG. 5) detects a current temperature and temperature control unit 302 determines whether the current temperature is less than or equal to a normal heating low temperature. If the current temperature is less than or equal to the normal heating low temperature, system 300 moves to step 144 where a heating unit 306 (FIG. 5) is activated. Once heating unit 306 (FIG. 5) is active, system 300 moves to step 146. At step 146, heating unit 306 (FIG. 5) remains active until temperature sensor 310 (FIG. 5) detects that the current temperature equals or is greater than a normal heating high temperature. When the current temperature equals or is greater than the normal heating high temperature, system 300 proceeds to step 148 where a total degree heated and a total heating time are measured and an average heating time per degree is calculated and updated by temperature analysis module 324 and temperature processing module 322 (FIG. 5). From step 148, system 300 proceeds to step 150 where heating unit 306 (FIG. 5) is switched off and then returns to step 142.

In one embodiment, the average heating time per degree is calculated and updated as a total degree heated per total time by temperature analysis module 324 and temperature processing module 322, and based on the live data stored in memory 318 of temperature control unit 302 (FIG. 5). Temperature control unit 302 may display an approximate time it will take to reach the settings inputted by the user based on these values on user interface 314.

In one exemplary embodiment, the heating mode of system 300 also features an automatic cooling switch over temperature range which is above the range defined by the normal heating low temperature and the normal heating high temperature. The automatic cooling switch over temperature range is defined between a normal heat mode cooling low temperature and a normal heat mode cooling high temperature.

Referring back to step 142, if the temperature sensor 310 (FIG. 5) detects a current temperature that is not less than or equal to the normal heating low temperature, system 300 proceeds to step 152. At step 152, the temperature sensor 310 (FIG. 5) detects the current temperature of system 300 and determines whether the current temperature is greater than or equal to the normal heat mode cooling high temperature. If this is not the case, system 300 returns to step 142. If the current temperature is greater than or equal to the normal heat mode cooling high temperature, system 300 proceeds to step 154 where a cooling unit 308 (FIG. 5) is activated. In one embodiment, cooling unit 308 (FIG. 5) of system 300 is an air conditioning unit. Once cooling unit 308 (FIG. 5) is activated, system 300 proceeds to step 156. At step 156, the temperature sensor 310 (FIG. 5) measures a current temperature and temperature control unit 302 determines whether it is equal to normal heat mode cooling low temperature. If this condition is not satisfied, the cooling unit 308 (FIG. 5) will remain active until the condition is satisfied. Once the condition is satisfied, system 300 proceeds to step 158 where the cooling unit 308 (FIG. 5) is switched off. System 300 then returns to step 142.

### Peak Mode

As shown in FIG. 1, in one exemplary embodiment, the control system 300 includes a Peak mode, in which there are settings for peak energy times where different temperature ranges as well as different humidity ranges can be specified. These settings will be used during peak times. Peak times include when many people are in the area. Therefore, the system can be more active and responsive as the temperature and humidity ranges would be narrower.

As shown in FIG. 1, if the user selects peak mode at step 100, system 300 then progresses to step 102, where system 300 receives a “Yes” response and proceeds to step 104. At step 104, system 300 determines variable values based on the user inputs received in step 100. At step 104, the cooling start temperature is set to the input value for PCH, which represents peak cooling high temperature. Also, the cooling end temperature is set to the input value for PCL, which is peak cooling low temperature. The cooling mode heat end temperature is set to the input value for PCMHH, which represents peak cool mode heat high temperature. The cooling mode heat starting temperature is set to the input value for PCMHL, which is peak cooling mode heat low temperature. Additionally, the heating start temperature is set to the input value for PHL, peak heating low temperature; the heating end temperature is set to the input value for PHH, peak heating high temperature; the heat mode cooling start temperature is set to the input value for PHMCH, which represents peak heat mode cool high temperature; the heat mode cooling end temperature is set to the input value for PHMCL, which represents peak heat mode cool low temperature; and the high humidity is set to the input value for PHH, peak high humidity.

After a user selects peak mode, system 300 proceeds to step 112, where system 300 determines if a heating mode is on. If the heating mode is on, system 300 receives a “Yes” response and system 300 proceeds to step 114. If heating mode is off, system 300 receives a “No” response and proceeds to step 116. In another embodiment, a heating mode and a cooling mode can be active simultaneously.

Referring to FIG. 2, at step 116, a heating mode is inactive and system 300, now in a cooling mode, proceeds to step 118. At step 118, a temperature sensor 310 (FIG. 5) detects whether the current temperature, denoted as CT, is greater than or equal to a peaking cooling high temperature. If the temperature detection unit detects that the current temperature is greater than the peak cooling high temperature, then system 300 proceeds to step 120 where a cooling unit 308 (FIG. 5) is activated. In one embodiment, a cooling unit 308 of system 300 is an air conditioning unit. While system 300 is performing its cooling operation, the temperature sensor 310 (FIG. 5) is monitoring the current temperature and comparing it to the peak cooling low temperature as denoted in step 122. When these two values are equal, system 300 proceeds to step 124. At step 124, a humidity sensor 312 (FIG. 5) of system 300 measures a current humidity (denoted as CH). A humidity control unit 304 (FIG. 5) then determines the difference between the current humidity and a peak high humidity value. If the difference is greater than or equal to 1% relative humidity, system 300 proceeds to step 126. If the difference between the current humidity and the peak high humidity is not greater than or equal to 1% relative humidity, system 300 proceeds to step 130, where total degree cooled and total cooling time are measured and an average cooling time per degree is calculated and updated by temperature analysis module 324 and temperature processing module 322 (FIG. 5). From step 130, system 300 proceeds to step 132 where cooling unit 308 (FIG. 5) is switched off, and system 300 then returns to step 118.

In one embodiment, the average cooling time per degree is determined and updated as a total degree cooled per total time by temperature processing module 322 and temperature analysis module 324. Based on the live data stored in memory 318 of temperature control system 300 (FIG. 5), temperature control unit 302 utilizes this information to notify the user via user interface 314 of the approximate time it will take to reach the settings inputted by the user.

At step 126, system 300 checks to see if humidity compensate mode is on. The humidity compensate mode can be switched on or off for peak mode such that the settings could apply humidity compensate only during peak hours and not for normal or away mode. If the humidity compensate mode is off, then system 300 proceeds to steps 130 and 132 as described above. If the humidity compensate mode is on, system 300 proceeds to step 128 where the humidity sensor 312 (FIG. 5) determines whether the current temperature is equal to the difference between the peak cooling low temperature and a humidity compensation delta. In one embodiment, the humidity compensation delta has a default value for system 300. In another embodiment, the humidity compensation delta is a value that a user enters into system 300. If the difference between the cooling end temperature and a humidity compensation delta does not equal the current temperature, system 300 returns to step 120. At step 120, cooling is performed, and the system behavior associated with steps 122, 124, 126, and 128 are executed. If the difference between the peak cooling low temperature and a humidity compensation delta is equal to the current temperature, then system 300 proceeds to steps 130 and 132 as described earlier.

In one exemplary embodiment, the cooling mode of system 300 also features an automatic heating switch over temperature range which is below the lower range of the peak cooling low temperature and the peak cooling high temperature. The automatic heating switch over temperature range is defined between a peak cool mode heat low temperature and a peak cool mode heat high temperature.

Referring back to step 118, if the temperature sensor 310 (FIG. 5) detects that the current temperature is not greater than or equal to the peak cooling high temperature, system 300 proceeds to step 134 where temperature control unit 302 (FIG. 5) measures the current temperature with temperature sensor 310 and determines whether the current temperature is less than or equal to a peak cool mode heat low temperature. If the current temperature is not less than or equal to the peak cool mode heat low temperature, then system 300 returns to step 118.

If the current temperature is less than or equal to the peak cool mode heat low temperature, then a heating unit 306 (FIG. 5) of system 300 is activated by a controller (FIG. 5) as indicated in step 136. In one embodiment, a heating unit 306 (FIG. 5) of system 300 is a heater. Once the heating unit 306 (FIG. 5) is active, system 300 proceeds to step 138. At step 138, heating unit 306 (FIG. 5) is active until the temperature sensor 310 (FIG. 5) detects that the current temperature is equal to a peak cool mode heat high temperature. Once the temperature sensor 310 (FIG. 5) detects that the current temperature is equal to the peak cool mode heat high temperature, system 300 proceeds to step 140 where the heating unit 306 (FIG. 5) is switched off. System 300 then proceeds to step 118.

Referring now to FIG. 3, a heating mode is active at step 114. From step 114, system 300 proceeds to step 142 where a temperature sensor 310 (FIG. 5) detects a current temperature and temperature control unit 302 determines whether the current temperature is less than or equal to a peak heating low temperature. If the current temperature is less than or equal to a peak heating low temperature, system 300 moves to step 144 where a heating unit 306 (FIG. 5) is activated. Once heating unit 306 (FIG. 5) is active, system 300 moves to step 146. At step 146, heating unit 306 (FIG. 5) remains active until temperature sensor 310 (FIG. 5) detects that the current temperature equals a peak heating high temperature. When the current temperature equals the peak heating high temperature, system 300 proceeds to step 148 where a total degree heated and a total heating time are measured and an average heating time per degree is calculated and updated by temperature analysis module 324 and temperature processing module 322 (FIG. 5). From step 148, system 300 proceeds to step 150 where heating unit 306 (FIG. 5) is switched off and then returns to step 142.

In one embodiment, the average heating time per degree is calculated and updated as a total degree heated per total time by temperature analysis module 324 and temperature processing module 322. Based on the live data stored in memory 318 of system 300 (FIG. 5), temperature control unit 302 utilizes this information to notify the user via user interface 314 of the approximate time it will take to reach the settings inputted by the user.

In one exemplary embodiment, the heating mode of system 300 also features an automatic cooling switch over temperature range which is above the range defined by the peak heating low temperature and the peak heating high temperature. The automatic cooling switch over temperature range is defined between a peak heat mode cool low temperature and a peak heat mode cool high temperature.

Referring back to step 142, if the temperature sensor 310 (FIG. 5) detects a current temperature that is not less than or equal to the peak heating low temperature, system 300 proceeds to step 152. At step 152, the temperature sensor 310 (FIG. 5) detects the current temperature of system 300 and determines whether the current temperature is greater than or equal to the peak heat mode cool high temperature. If this is not the case, system 300 returns to step 142. If the current temperature is greater than or equal to the peak heat mode cool high temperature, system 300 proceeds to step 154 where a cooling unit 308 (FIG. 5) is activated. In one embodiment, cooling unit 308 (FIG. 5) of system 300 is an air conditioning unit. Once cooling unit 308 (FIG. 5) is activated, system 300 proceeds to step 156. At step 156, the temperature sensor 310 (FIG. 5) measures a current temperature and temperature control unit 302 determines whether it is equal to a peak heat mode cool low temperature. If this condition is not satisfied, the cooling unit 308 (FIG. 5) will remain active until the condition is satisfied. Once the condition is satisfied, system 300 proceeds to step 158 where the cooling unit 308 (FIG. 5) is switched off. System 300 then returns to step 142.

### Away Mode

As shown in FIG. 1, in one exemplary embodiment, the control system 300 includes an away mode, in which there are settings for away times where different temperature ranges as well as different humidity ranges can be specified. These settings will be used during away times. Away times can include times when fewer or no people are in the area and thus the system can utilize less energy provided that the desired temperature and humidity ranges are wider.

As shown in FIG. 1, if a user selects away mode at step 100, system 300 then progresses to step 102, where system 300 receives a “No” response and proceeds to step 106. At step 106, system 300 receives a “Yes” response and determines variable values based on the user inputs received in step 100. At step 104, the cooling start temperature is set to the input value for ACH, which represents away cooling high temperature. Also, the cooling end temperature is set to the input value for ACL, which is an away cooling low temperature. The cooling mode heat end temperature is set to the input value for ACMHH, which represents an away cooling mode heat high temperature. The cooling mode heat starting temperature is set to the input value for ACMHL, which is an away cooling mode heat low temperature. Additionally, the heating start temperature is set to the input value for AHL, away heating low temperature; the heating end temperature is set to the input value for AHH, away heating high temperature; the heat mode cooling start temperature is set to the input value for AHMCH, which represents away heat mode cool high temperature; the heat mode cooling end temperature is set to the input value for AHMCL, which represents peak heat mode cool low temperature; and the high humidity is set to the input value for AHH, away high humidity.

After a user selects away mode, system 300 proceeds to step 112, where system 300 determines if a heating mode is on. If the heating mode is on, system 300 receives a “Yes” response and system 300 proceeds to step 114. If heating mode is off, system 300 receives a “No” response and proceeds to step 116. In another embodiment, a heating mode and a cooling mode can be active simultaneously.

Referring to FIG. 2, at step 116, a heating mode is inactive and system 300, now in a cooling mode, proceeds to step 118. At step 118, a temperature sensor 310 (FIG. 5) detects whether the current temperature, denoted as CT, is greater than or equal to an away cooling high temperature. If the temperature detection unit detects that the current temperature is greater than the away cooling high temperature, then system 300 proceeds to step 120 where a cooling unit 308 (FIG. 5) is activated. In one embodiment, a cooling unit 308 of system 300 is an air conditioning unit. While system 300 is performing its cooling operation, the temperature sensor 310 (FIG. 5) continues monitoring the current temperature and temperature control unit 302 compares it to the away cooling low temperature as denoted in step 122. When these two values are equal, or the current temperature is less than the away cooling low temperature, system 300 proceeds to step 124. At step 124, a humidity sensor 312 (FIG. 5) of system 300 measures a current humidity (denoted as CH). A humidity sensor 312 (FIG. 5) then measures the difference between the current humidity and an away high humidity value. If the difference is greater than or equal to 1% relative humidity, system 300 proceeds to step 126. If the difference between the current humidity and the away high humidity is not greater than or equal to 1% relative humidity, system 300 proceeds to step 130, where total degree cooled and total cooling time are measured and an average cooling time per degree is calculated and updated by temperature analysis module 324 and temperature processing module 322 (FIG. 5). From step 130, system 300 proceeds to step 132 where cooling unit 308 (FIG. 5) is switched off, and system 300 then returns to step 118.

In one embodiment, the average cooling time per degree is determined and updated as a total degree cooled per total time by temperature processing module 322 and temperature analysis module 324. Based on the live data stored in memory 318 of system 300 (FIG. 5), temperature control unit 302 utilizes this information to notify the user via user interface 314 of the approximate time it will take to reach the settings inputted by the user.

At step 126, system 300 checks to see if humidity compensate mode is on. The humidity compensate mode can be switched on or off for away mode such that the settings could apply humidity compensate only during away hours and not for normal or peak mode. If the humidity compensate mode is off, then system 300 proceeds to steps 130 and 132 as described above. If the humidity compensate mode is on, system 300 proceeds to step 128 where the humidity detection unit 300 (FIG. 5) determines whether the current temperature is equal to the difference between the away cooling low temperature and a humidity compensation delta. In one embodiment, the humidity compensation delta has a default value for system 300. In another embodiment, the humidity compensation delta is a value that a user enters into system 300. If the difference between the away cooling low temperature and a humidity compensation delta does not equal the current temperature, system 300 returns to step 120. At step 120, cooling is performed, and the system behavior associated with steps 122, 124, 126, and 128 are executed. If the difference between the away cooling low temperature and a humidity compensation delta is equal to the current temperature, then system 300 proceeds to steps 130 and 132 as described earlier.

In one exemplary embodiment, the cooling mode of system 300 also features an automatic heating switch over temperature range which is below the lower range of the away cooling low temperature and the away cooling high temperature. The automatic heating switch over temperature range is defined between an away cool mode heat low temperature and an away cool mode heat high temperature.

Referring back to step 118, if the temperature sensor 310 (FIG. 5) detects that the current temperature is not greater than or equal to the away cooling high temperature, system 300 proceeds to step 134 where temperature sensor 310 (FIG. 5) measures the current temperature and the temperature control unit 302 determines whether the current temperature is less than or equal to an away cool mode heat low temperature. If the current temperature is not less than or equal to the away cool mode heat low temperature, then system 300 returns to step 118.

If the current temperature is less than or equal to the away cool mode heat low temperature, then a heating unit 306 (FIG. 5) of system 300 is activated by a controller (FIG. 5) as indicated in step 136. In one embodiment, a heating unit 306 (FIG. 5) of system 300 is a heater. Once the heating unit 306 (FIG. 5) is active, system 300 proceeds to step 138. At step 138, heating unit 306 (FIG. 5) is active until the temperature sensor 310 (FIG. 5) detects that the current temperature is equal to an away cool mode heat high temperature. Once the temperature sensor 310 (FIG. 5) detects that the current temperature is equal to the away cool mode heat high temperature, system 300 proceeds to step 140 where the heating unit 306 (FIG. 5) is switched off. System 300 then proceeds to step 118.

Referring now to FIG. 3, a heating mode is active at step 114. From step 114, system 300 proceeds to step 142 where a temperature sensor 310 (FIG. 5) detects a current temperature and temperature control unit 302 determines whether the current temperature is less than or equal to an away heating low temperature. If the current temperature is less than or equal to an away heating low temperature, system 300 moves to step 144 where a heating unit 306 (FIG. 5) is activated. Once heating unit 306 (FIG. 5) is active, system 300 moves to step 146. At step 146, heating unit 306 (FIG. 5) remains active until temperature sensor 310 (FIG. 5) detects that the current temperature equals an away heating high temperature. When the current temperature equals the away heating high temperature, system 300 proceeds to step 148 where a total degree heated and a total heating time are measured and an average heating time per degree is calculated and updated by temperature analysis module 324 and temperature processing module 322 (FIG. 5). From step 148, system 300 proceeds to step 150 where heating unit 306 (FIG. 5) is switched off and then returns to step 142.

In one embodiment, the average heating time per degree is calculated and updated as a total degree heated per total time by temperature analysis module 324 and temperature processing module 322, and based on the live data stored in memory 318 of temperature sensor 310 (FIG. 5), control unit 200 utilizes this information to notify the user of the approximate time it will take to reach the settings inputted by the user.

In one exemplary embodiment, the heating mode of system 300 also features an automatic cooling switch over temperature range which is above the range defined by the away heating low temperature and the away heating high temperature. The automatic cooling switch over temperature range is defined between an away heat mode cool low temperature and an away heat mode cool high temperature.

Referring back to step 142, if the temperature sensor 310 (FIG. 5) detects a current temperature that is not less than or equal to the away heating low temperature, system 300 proceeds to step 152. At step 152, the temperature sensor 310 (FIG. 5) detects the current temperature and temperature control unit 302 determines whether the current temperature is greater than or equal to the away heat mode cooling high temperature. If this is not the case, system 300 returns to step 142. If the current temperature is greater than or equal to the away heat mode cooling high temperature, system 300 proceeds to step 154 where a cooling unit 308 (FIG. 5) is activated. In one embodiment, cooling unit 308 (FIG. 5) of system 300 is an air conditioning unit. Once cooling unit 308 (FIG. 5) is activated, system 300 proceeds to step 156. At step 156, the temperature sensor 310 (FIG. 5) measures a current temperature and determines whether it is equal to an away heat mode cooling low temperature. If this condition is not satisfied, the cooling unit 308 (FIG. 5) will remain active until the condition is satisfied. Once the condition is satisfied, system 300 proceeds to step 158 where the cooling unit 308 (FIG. 5) is switched off. System 300 then returns to step 142.

When temperature control system 300 of FIG. 5 also controls a humidifier 307, a dehumidifier 309, variable speed fans 330, and an external air ventilating system 332, additional features are available.

When in heating mode, if the external air temperature is higher than the indoor air temperature, system 300 intakes external air until the indoor air temperature reaches the heating end temperature or the internal air temperature becomes the external temperature, whichever is lower. This process is diagrammed in FIG. 3. At step 142, if the temperature sensor 310 (FIG. 5) detects a current temperature (CT) that is less than or equal to the heating start temperature (HS), system 300 proceeds to step 143. At step 143, if the external temperature sensor 311 detects an external temperature (ET) less than the current temperature, system 300 proceeds to step 145, where external air ventilating system 332 intakes external air and the system 300 proceeds to step 147. If, at step 147, temperature sensor 310 detects a current temperature equal to or greater than the heating end temperature (HE), the system proceeds to step 148. If, at step 147, temperature sensor 310 detects a current temperature less than the heating end temperature, system 300 returns to step 143.

Referring back to step 143, if the external temperature sensor 311 detects an external temperature equal to or less than the current temperature, system 300 proceeds to step 144, where heating unit 306 is activated, and the system proceeds to step 146. If, at step 146, the current temperature is not equal to the heating end temperature (HE), the system 144 and the heating unit 306 remains activated. If, at step 146, the current temperature is equal to the heating end temperature, system 300 proceeds to step 148 where a total degree heated and a total heating time are measured and an average heating time per degree is calculated and updated by temperature analysis module 324 and temperature processing module 322 (FIG. 5). From step 148, system 300 proceeds to step 150 where heating unit 306 (FIG. 5) is switched off and then returns to step 142.

When in cooling mode, if the external air temperature is lower than the indoor air temperature, system 300 intakes external air until in the indoor air temperature reaches the cooling end temperature or the internal air temperature becomes the external temperature, whichever is higher. This process is diagrammed in FIG. 2. At step 118, if the temperature sensor 310 (FIG. 5) detects a current temperature (CT) that is greater than or equal to the cooling start temperature (CS), system 300 proceeds to step 119. At step 119, if the current temperature is not greater than an external temperature (ET) detected by external temperature sensor 311, system 300 proceeds to step 120 as described above. At step 119, if the current temperature is greater than an external temperature detected by external temperature sensor 311, system 300 proceeds to step 121, where external air ventilating system 332 intakes external air and the system 300 proceeds to step 123. If, at step 123, the current temperature is still greater than the external temperature detected by external temperature sensor 311, system 300 proceeds to step 124 as described above. If, at step 123, the current temperature is not greater than the external temperature detected by external temperature sensor 311, system 300 proceeds back to step 119 as indicated in FIG. 2.

In one exemplary embodiment, when indoor humidity is high, the system 300 will activate dehumidifier 309 until the indoor humidity reaches the desired humidity range.

In one exemplary embodiment, when indoor humidity is low, humidifier 307 is activated until the indoor humidity reaches the desired humidity levels.

In one exemplary embodiment, if the rate at which the room air temperature is increasing (Average Heating time/deg while cooling) during cooling mode is more than the average rate at which cooling can be done (Average Cooling time per Deg), system 300 will start the cooling mode immediately. In this way, if the room is warming faster than it can be cooled, system 300 will start cooling the room immediately. In a further embodiment, a user has the option to activate or deactivate this feature during one or more of peak mode, away mode, and regular modes.

In one exemplary embodiment, if the external air temperature is lower than the indoor air temperature during cooling mode, system 300 intakes external air until the indoor air temperature reaches the cooling end temperature or the internal air temperature becomes the external air temperature, whichever is higher. In a further embodiment, if extra cooling is required for humidity reduction, system 300 activates variable speed fans 330 at low fan speed to achieve better humidity reduction. In a still further embodiment, system 300 activates dehumidifier 309 during high humidity and when humidity reduction is required.

In one exemplary embodiment, if the current humidity is 10% above the desired humidity during cooling mode, the cooling start temperature, which activates the start of cooling, is reduced by 1° F. for every 10% humidity above the desired humidity until the cooling start temperature is 1° F. above the heating start temperature. In a further embodiment, a user has the option to activate or deactivate this feature during one or more of peak mode, away mode, and regular modes.

In one exemplary embodiment, the system 300 (FIG. 5) records the energy consumption during the starting and running of cooling unit 308, heating unit 306, and/or the running of variable speed fans 330. In another exemplary embodiment, the system 300 (FIG. 5) further determines and reports the total energy consumption for cycle starts of cooling unit 308 and heating unit 306, the number of starts of cooling unit 308 and heating unit 306, the total energy consumption for cycle run time for cooling unit 308 and heating unit 306, and the total energy consumption for variable speed fans 330 only for a selected period range. In another exemplary embodiment, the system 300 (FIG. 5) uses the average cooling time/deg and energy consumption for the both the start and running of cooling unit 308 to calculates the optimum duration of run per start and its associated temperature difference. In an exemplary situation, a temperature difference will exist when a room's desired temperature and its current temperature are different. The size of the temperature difference depends on the room's desired temperature. The further away the room's current temperature is from the desired temperature, the greater the temperature difference. Conversely, the closer the room's current temperature is to desired temperature, the smaller the temperature difference. The system 300 (FIG. 5) determines an optimum run time for a given temperature difference based on the average time to cool per degree of cooling unit 308 as well as its energy consumption during its start and running.

FIG. 4 shows an exemplary control unit 200 for system 300. In one exemplary embodiment, control unit 200 includes temperature control unit 302, humidity control unit 304, and user interface 314. Control unit 200, as shown in FIG. 4 includes a display 202, an up control 204, a down control 206, a next control 210, and a mode control 208. Display 202 provides the user with feedback based on the user's input into control unit 200 and by extension, system 300 (e.g., time for achieving desired settings, the temperature range desired, the current temperature, the desired humidity, the mode selected, etc.). Although illustrated as individual buttons in FIG. 4, controls 204, 206, 208, and 210 in other embodiments may be combined into one or more controls, and may be one or more of switches, buttons, rotatable inputs, touch screen icons, and the like.

In the exemplary embodiment shown in FIG. 4, the up control 204 is a button that allows the user to increase a value (e.g., the cooling start temperature) in system 300. Similarly, the down control 206 is a button that allows the user to increase a value in system 300 (e.g., the cooling start temperature). Mode control 208 allows the user to control system 300 among various modes—normal, peak, and away. In one embodiment, mode control 208 can also be used to control between heating and cooling modes. In another embodiment, the control unit 200 can be monitored and the settings can be changed by internet connected devices such as a smartphone, a computer, or a tablet.

In one exemplary embodiment, control unit 200 accepts user inputs for one or more of a cooling start temperature (CS), a cooling end temperature (CE), a cooling mode heat end temperature (CMHE), a cooling mode heat start temperature (CMHS), a heating start temperature (HS), a heating end temperature (HE), a heating mode cooling start temperature (HMCS), a heating mode cool end temperature (HMCE), and a high humidity (HH). In one embodiment, these inputs are used in system 300 as shown in FIG. 1. In one exemplary embodiment, control unit 200 prompts the user to enter another set of temperatures when the user selects peak mode or away mode. In another exemplary embodiment, control unit 200 allows the user to select specific times for different modes to be active so that less user interaction with system 300 is needed. After the values are entered into control unit 200, system 300 will equate the values based on the mode selected by the user—normal, away, peak, heating, and cooling—and operate as shown in FIGS. 1-3.

Referring again to FIGS. 4-5, in one exemplary embodiment, system 300 is configured to accept inputs from a user through user interface 314. Exemplary inputs include feedback from the user regarding the current temperature and/or humidity conditions. In an exemplary embodiment, system 300 displays an inquiry on display 202 for the user to respond to. One exemplary inquiry asks whether the user finds the present temperature is too hot, comfortable, or too cold. One exemplary inquiry asks whether the user finds the present humidity too humid, comfortable, or too cold. The system 300 receives input from the user, such as through button controls 204, 206, 208, and 210, indicating the user's preference regarding temperature and/or humidity. In one exemplary embodiment, the system 300 stores the user input in memory 318. In one exemplary embodiment, the system 300 uses the user input in memory 318 from one or more inquiries to identify a comfortable range of temperatures and/or humidity levels that the user finds comfortable. In one exemplary embodiment, the system 300 adjusts the current temperature and/or humidity set point at least in part based on the user input and one or more of the current time of day, the current internal temperature, the current internal humidity, the current external temperature, and the current external humidity.

Referring again to FIG. 5, in one exemplary embodiment, the temperature control system 300 includes a multi-stage heating unit 306 and/or cooling unit 308, or a variable speed system such as variable speed fans 330. In one exemplary embodiment, temperature control unit 302 and/or humidity control unit 304 determines the most economical number or selection of stages for the multi-stage heating unit 306 and/or cooling unit 308, or the most economical speed for variable speed fans 330 to maintain the temperature and/or humidity within the comfortable range of temperature and/or humidity levels based on the user input in memory 318. When cooling, if the current temperature and/or humidity starts to increase, the temperature control unit 302 and/or humidity control unit 304 increases the number of stages of the multi-stage cooling unit 308 and/or increase the speed of variable speed vans to provide more cooling power. When heating, if the current temperature starts to decrease, the temperature control unit 302 increases the number of stages of the multi-stage heating unit 306 and/or increase the speed of variable speed vans to provide more heating power.

In the exemplary embodiment shown in FIG. 5, temperature control system 300 is further capable of controlling a humidifier 307, a dehumidifier 309, variable speed fans 330, and an external air ventilating system 332. In addition, temperature control system 300 includes an external temperature sensor 311 and an external humidity sensor 313.

Referring next to FIG. 6, an exemplary method 400 is illustrated for controlling temperature with temperature control system 300 (see FIG. 5) including a multistage or variable speed system. In step 402, a user inputs a target temperature, which is the desired temperature, and an upper limit and a lower limit. In step 404, the temperature control system 300 determines a current temperature of the area with temperature sensor 310 and the current relative humidity of the area with humidity sensor 312.

In step 406, temperature control system 300 compares the determined temperature and humidity to a prior temperature and humidity determined by temperature sensor 310 and humidity sensor 312. If step 406 indicates that either the temperature or humidity is increasing, the method proceeds to step 408. If step 406 indicates that the temperature is decreasing, the method proceeds to step 418. If step 406 indicates some other outcome, the method returns to step 404.

In step 408, the temperature control system 300 determines whether a fan is on. If the fan is not on, in step 410 the temperature control system 300 activates the fan, and the method returns to step 404. If the fan is already on, in step 412 the temperature control system 300 determines whether the cooling unit 308 is already on. if the cooling unit 308 is not activated, in step 414 the temperature control system 300 activates the cooling unit 308 and the method returns to step 404. If the cooling unit 308 is already activated, in step 416 the cooling power of the cooling unit 308 is increased, such as by increasing the speed of a variable speed system or by increasing the number of stages active in a multistage system. The method then returns to step 404.

In step 418, the temperature control system 300 determines whether a fan is on. If the fan is not on, in step 420 the temperature control system 300 activates the fan, and the method returns to step 404. If the fan is already on, in step 422 the temperature control system 300 determines whether the heating unit 306 is already on. if the heating unit 306 is not activated, in step 424 the temperature control system 300 activates the heating unit 306 and the method returns to step 404. If the heating unit 306 is already activated, in step 426 the heating power of the heating unit 306 is increased, such as by increasing the speed of a variable speed system or by increasing the number of stages active in a multistage system. The method then returns to step 404.

Referring next to FIG. 7, an exemplary method 500 is illustrated for controlling temperature with temperature control system 300 (see FIG. 5) including a single stage system. In one exemplary embodiment, the temperature analysis module 324 includes historical data for heating and/or cooling the area, including a maximum possible heating rate provided by heating unit 306 and a maximum possible cooling rate provided by cooling unit 308 for temperature control system 300.

In step 502, a user inputs a target temperature, which is the desired temperature, and an upper limit and a lower limit. In step 504, temperature control system 300 determines the current temperature of the area with temperature sensor 310. In step 506, the current temperature determined by the temperature sensor 310 is compared to a prior temperature to provide a current rate of heating (if the current temperature is greater than the prior temperature) or a current rate of cooling (if the current temperature is less than the prior temperature). If the current temperature is greater than the prior temperature, the method proceeds to step 508. if the current temperature is less than the prior temperature, the method proceeds to step 514. If the current temperature is equal to the prior temperature, the method returns to step 504.

In step 508 the current temperature is compared to the upper limit from step 502. in step 512, the current rate of heating is compared to a predetermined maximum possible cooling rate of temperature control system 300. If the current temperature exceeds the upper limit in step 508, or if the current rate of heating exceeds to maximum possible cooling rate in step 512, in step 510 the cooling unit 308 is activated, and the method returns to step 504. Otherwise, the method returns to step 504.

In step 514 the current temperature is compared to the lower limit from step 502. in step 518, the current rate of cooling is compared to a predetermined maximum possible heating rate of temperature control system 300. If the current temperature exceeds the upper limit in step 514, or if the current rate of heating exceeds to maximum possible cooling rate in step 518, in step 516 the heating unit 306 is activated, and the method returns to step 504. Otherwise, the method returns to step 504.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the practice in the art to which this disclosure pertains and which fall within the limits of the appended claims.

1-56. (canceled)

57. A system comprising:
a heating unit;
a cooling unit;
a temperature detection unit detecting a current temperature;
a temperature control unit receiving the current temperature from the temperature detection unit, wherein the temperature control unit comprises a user interface configured to accept a user input for a first temperature and a user input for a second temperature wherein the first temperature is less than the second temperature;
wherein the temperature control unit is configured to activate the heating unit when the current temperature is less than the first temperature and to activate the cooling unit when the current temperature is greater than the second temperature until the temperature detection unit detects a current temperature between the first temperature and second temperature.

58. The system of claim 57, wherein the user interface is configured to accept a user input for a third temperature, and a user input for a fourth temperature.

59. The system of claim 58, wherein the third temperature and the fourth temperature are each less than the first temperature; and the fourth temperature is less than the third temperature.

60. The system of claim 58, wherein the temperature control unit is configured to activate the heating unit when the temperature detection unit detects that the current temperature is less than or equal to the fourth temperature.

61. The system of claim 59, wherein the temperature control unit is configured to activate the heating unit until the temperature detection unit detects the current temperature is equal to the third temperature.

62. The system of claim 57, wherein when the temperature control unit is configured to activate the cooling unit when temperature detection unit detects the current temperature greater than or equal to the second temperature.

63. The system of claim 57, wherein the temperature control unit is configured to determine an average cooling time per degree, wherein the average cooling time per degree is a quotient of a total cooling time and a total degree cooled.

64. The system of claim 57, wherein the temperature control unit is configured to determine an average heating time per degree, wherein the average heating time per degree is a quotient of a total heating time and a total degree heated.

65. A method of controlling a temperature in a space, the method comprising:
receiving a first temperature and a second temperature, wherein the first temperature is less than the second temperature, and the first and the second temperatures define a temperature range;
determining a current temperature within the space;
activating a heating unit to heat the space when the temperature is less than the first temperature until the current temperature is within the temperature range; and
activating a cooling unit to cool the space when the temperature is greater than the second temperature until the current temperature is within the temperature range.

66. A method of controlling a temperature and/or a humidity in a space, the method comprising:
receiving a first input from a user relating to the user's comfort of at least one of a current temperature and a current humidity;
determining a comfort range of temperature and/or humidity based on the received user input;
adjusting a current temperature and/or a humidity level within the space based in part on the comfort range and at least one of a current time of day, a current temperature in the space, a current humidity in the space, a current temperature external to the space, and a current humidity external to the space.

67. The method of claim 66, further comprising a multi-stage or variable speed heating unit, the method further comprising the steps of:
monitoring a current temperature within the space;
maintaining the temperature within the comfort range, wherein said maintaining includes increasing a number of stages or a speed of the heating unit when the monitored current temperature decreases.

68. The method of claim 66, further comprising a multi-stage or variable speed cooling unit, the method further comprising the steps of:
monitoring a current temperature within the space;
maintaining the temperature within the comfort range, wherein said maintaining includes increasing a number of stages or a speed of the cooling unit when the monitored current temperature increases.

69. The method of claim 66, further comprising a multi-stage or variable speed cooling unit, the method further comprising the steps of:
monitoring a current humidity within the space;
maintaining the humidity within the comfort range, wherein said maintaining includes increasing a number of stages or a speed of the cooling unit when the monitored current humidity increases.

70. A method of controlling a temperature in a space with a heating unit comprising a plurality of stages and a cooling unit comprising a plurality of stages, the method comprising:
receiving a target temperature, an upper temperature limit, and a lower temperature limit;
determining a current temperature and relative humidity of the space;
comparing the determined current temperature with a prior temperature of the space and comparing the determined relative humidity with a prior relative humidity of the space;
activating one or more of the plurality of stages of the cooling unit if the current temperature is greater than the prior temperature or the current humidity is greater than the prior humidity; and
activating one or more of the plurality of stages of the heating unit if the current temperature is less than the prior temperature.

71. A method of controlling a temperature in a space with a heating unit and a cooling unit, the method comprising:
receiving a target temperature, an upper temperature limit, and a lower temperature limit;
determining a maximum possible cooling rate of the space with the cooling unit;
determining a maximum possible heating rate of the space with the heating unit;
determining a current temperature and a current heating or cooling rate of the space;
comparing the determined current temperature with a prior temperature of the space;
activating the cooling unit if the current temperature is greater than the upper temperature limit or if the determined current heating rate exceeds the determined maximum possible cooling rate of the space with the cooling unit;
activating the heating unit if the current temperature is less than the lower temperature limit or if the determined current cooling rate exceeds the determined maximum possible heating rate of the space with the heating unit;
activating one or more of the plurality of stages of the cooling unit if the current temperature is greater than the prior temperature or the current humidity is greater than the prior humidity; and
activating one or more of the plurality of stages of the heating unit if the current temperature is less than the prior temperature.
